(19) United States
(12) Patent Application Publication
(10) Pub. No.: US 2005/0243343 A1
(43) Pub. Date: Nov. 3, 2005

(54) PMS color expansion with fifth color

(75) Inventor: Yee S. Ng, Fairport, NY (US)

Correspondence Address: Lawrence P. Kessler;Patent Department, NexPress Solutions LLC, 1447 St. Paul Street, Rochester, NY, 14653-7103, US

(73) Assignee: NexPress Solutions LLC

(21) Appl. No.: 10/837,051

(22) Filed: Apr. 30, 2004

(51) Int. Cl. G06F 15/00

(52) U.S. Cl. 358/1.9; 358/518

(57) ABSTRACT

A color accuracy prediction system is provided that will allow an operator to manage his workflow by deciding which color to insert as the fifth imaging unit (20) in the printer (10). A document's digital file is analyzed by the system to determine the specific colors specified therein. A table or diagram that lists the color accuracy values within a set tolerance is provided to the operator to allow a comparison of the color accuracy achievable by the installation of a specific fifth color. The operator can then evaluate if the color accuracy realized with the specific color justifies the time and expense of installing that specific fifth color. If the color accuracy will be realized, the operator can evaluate if the customer's job is important enough to justify installation of the fifth color. An operator can manage his workflow to replace the fifth imaging unit (20) at a desired time in his workflow.

### FIELD OF THE INVENTION

The present invention relates generally to a color accuracy prediction system that will aid a printer operator's decision of which color to install in the fifth station of a printer. This prediction system will enable a printer operator to balance increased color accuracy performance with workflow scheduling in a printing process.

### BACKGROUND OF THE INVENTION

A typical printing process includes four-color imaging units or stations (usually with standard colors, such as cyan, magenta, yellow, and black (CMYK) ink or toner). These four imaging units are capable of producing a color gamut that encompasses some of the panoply of specific color patches demanded by customer's job orders. The available gamut of specific color patches can be expanded in a printer by using more than four-color stations. In a five-color system (generally CMYK plus a fifth color), such as that available in the NexPress 2100 Premier system, the fifth color station can be interchanged to create a wider gamut that will encompass more specific color patch choices as requested by different customer jobs. With a fifth color station in the printer, certain five-color combinations broaden the color accuracy performance gamut to make certain sets of specific color available for printing. Heretofore, an operator had to manually exchange the fifth station to determine if an improvement in the color accuracy would be realized by the addition of that specific fifth color. However, in order to make an informed decision before changing the fifth station a number of times, a printer operator should be informed of the improvement in color accuracy performance that can be realized by the switching out, or installation, of a specific fifth station. The operator is then able to decide if the color accuracy performance justifies the time and effort expended to exchange the fifth station with a different color or if his workflow demands do not justify exchanging the fifth station.

### SUMMARY OF THE INVENTION

The present invention will provide a color accuracy prediction system that will assist an operator's decision of which color to insert in the fifth development station bay to maintain his workflow. The present color accuracy prediction system will analyze a customer's job to provide a listing of the specific patches in the document. Although most customer's jobs are provided to the printer operator as a digital file, any job could be scanned into memory and converted to a digital file before printing has begun. The digital file is then analyzed to determine the color requirements of each color patch requested in the document. A color coded table is provided to enable the operator to determine which specific colors are within the gamut of the traditional four development stations, which are within the gamut of four development stations with a tolerance, and which are within the gamut of five color stations. The table also indicates, in contrasting shades that will allow quick scanning of the table, the extent out-of-gamut for each specific color that is out-of-gamut of the four-station setup, of the four-stations with a tolerance, and of the five-station setup. The allowable tolerance is typically set by the manufacturer before the operator has received the printer. The color accuracy, or extent out-of-gamut, values provided in the table will enable comparison of the configuration of stations presently installed in the printer to the color accuracy achievable if the color gamut is increased by installing a fifth color in the fifth station.

The operator will then determine if he wants to install a different station as the fifth station. By using the color accuracy values in the table, the operator can evaluate whether the available gamut, enlarged by an installed fifth station, would include a specific color detailed in the digital file. If a justified amount of color accuracy would be realized by installing a fifth color, the operator can evaluate if the customer's job justifies installing such color in the fifth station. If the customer's job justifies installing the fifth color, the operator can manage his workflow to install the required color in the fifth station at an appropriate time.

These and other objects, features, and advantages of the present invention will become more apparent upon reading the following specifications in conjunction with the accompanying drawing figures.

### BRIEF DESCRIPTION OF THE DRAWINGS

FIG. 1 shows a printer with five imaging units;

FIG. 2 is a three-dimensional view of the CMYK gamut and out-of-gamut color patches;

FIG. 3 is a three-dimensional view of the CMYK gamut showing the out-of-gamut color patches of FIG. 1 with an allowance for tolerance;

FIG. 4 is a three-dimensional view of the CMYK gamut of FIG. 1 plus tolerance allowance with a green station installed in the fifth station;

FIG. 5 is a three-dimensional view of the CMYK gamut of FIG. 1 plus tolerance allowance with a red station installed as the fifth station;

FIG. 6 is a three-dimensional view of the CMYK gamut of FIG. 1 plus tolerance allowance with a blue station installed as the fifth station;

FIG. 7 is a chromaticity diagram of the fifth color combination with Pantone® patches in comparison to a four-color system gamut; and

FIG. 8 is a sample table of Pantone® colors specified by a digital file and the combinations available after installation of a green, red, or blue station as the fifth station.

### DETAILED DESCRIPTION OF THE INVENTION

According to the present system, in order to expand the specific color patches that are in-gamut, a fifth station can be included in the printer. The present system will assist an operator's determination of which station to install in the fifth station of the printer to bring specific colors in-gamut, or closer to in-gamut, for the printing of a customer's job.

An operator can utilize the table provided by his printer to group jobs in his workflow after each digital file is loaded. The operator can then evaluate his customer's jobs and weigh, for example, that the color accuracy of job 1 would be improved with red as the fifth color, the color accuracy of job 2 would be improved with green as the fifth color, the color accuracy of job 3 would be improved with blue as the fifth color, the color accuracy of job 4 would be improved with green as the fifth color, and the color accuracy of job 5 would be improved with red as the fifth color. The operator can then group his customer's jobs to improve color accuracy and improve efficiency by limiting the number of times that the fifth station is changed. In this example, the operator can group jobs 1 and 5 together and jobs 2 and 4 together, which will require switching the fifth station only once to complete these four jobs with improved color accuracy. Additionally, if the improvement realized in having a blue station installed for job 3 is minor in comparison to the improvement realized with performing the job with green installed in the fifth station, the operator can decide if the improved accuracy justifies exchanging the green station with the blue station. Otherwise, the operator can run job 3 with the green station; completing all jobs with the green station as desired. Therefore, the operator can evaluate the specific colors from the digital file, review the table, and manage his workflow.

Special terms used in this application include Pantone®, spot, and gamut. The Pantone® Matching System (PMS) is an industry standard color matching system. The Pantone® color formula guide provides an accurate method for selecting, specifying, broadcasting, and matching colors through any medium. Spot colors are special colors used in addition to, or instead of, the process colors CMYK to print special hues without mixing primary colors. Named colors and customer-named colors include any color a customer, industry, or business has named (e.g., Kodak yellow). A color gamut is the complete range or extent of colors available. In-gamut colors are colors that have a closer match to the specified requirements.

The present system, however, does not limit the operator and allows the fifth station to be interchanged by the operator as often as desired. The operator's decision to interchange the fifth station can be based upon any number of factors, including that a specific customer is not important enough, that a specific customer's job is not important enough, that the improvement realized in the color is not great enough, or that the gamut improvement is not great enough. If the operator deems the change unnecessary for any reason, he is not obligated to change the station. However, the present system will allow an operator, who desires to print every job as accurately as possible, to change the fifth station as often as desired while still enabling him to group jobs in his workflow to interchange the fifth station as few times as necessary.

The printer operator is able to manage his workflow and install a preferred color in the fifth station for improved color accuracy for a specific color for a customer's job that is deemed important. Workflow management typically is performed before undertaking a group of jobs and generally is based upon several factors, including the operator's reputation for accuracy, the evaluation of the digital file of the image, the color requirements of the specific color in the digital file, etc.

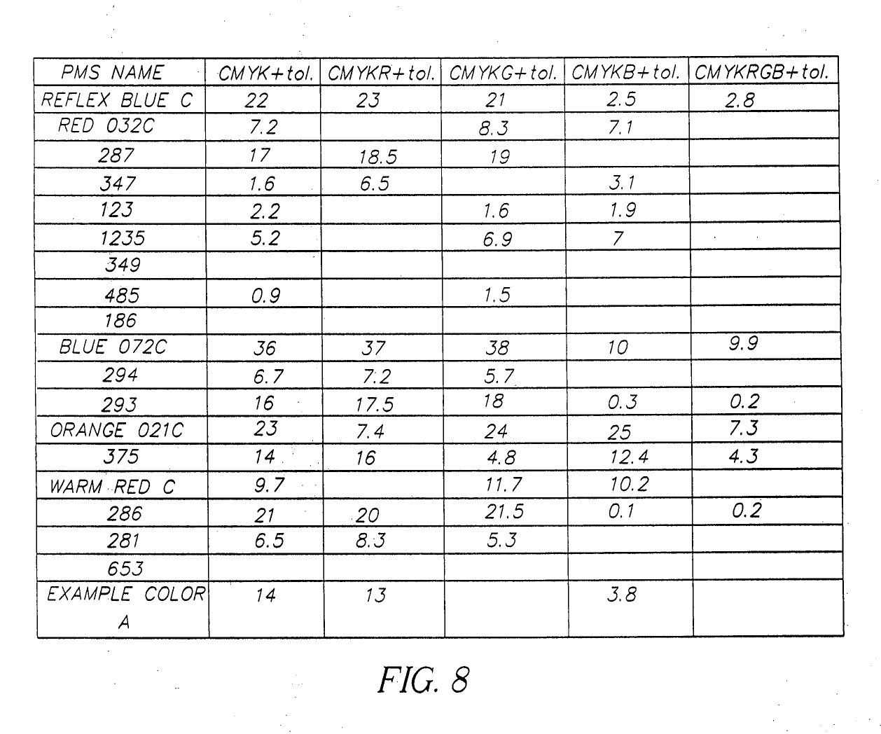

The digital file can be analyzed by any capable software, such as PitStop™ by EnFocus™, manufacturer provided software, etc., which will display a list of the specific colors, e.g. spot, Pantone®, named, customer-named colors, etc. The analyzed digital file is compared to a database of known specific colors and mapped to the gamut available with CMYK and with certain five-color combinations. Alternatively, a book that lists the specific color patch information and the CMYK combination can be provided by the manufacturer to the operator. The specific color gamut information from the digital file evaluation generally is provided in a tabular or chromaticity diagram format. However, the presentation and tolerance level can be customized by the operator. For instance, the individual blocks of a table or the representations on a chromaticity diagram can shade an in-gamut value green, can shade a slightly out-of-gamut value within the tolerance level yellow, and can shade an out-of-gamut value that is outside the tolerance level red. These colors are provided for example only and are also adjustable by the operator as desired. A sample table is provided in black and white in FIG. 8 with out-of-gamut values shown over a white background, out-of-gamut values that are within the set tolerance level shown over a gray background, and in-gamut values shown over a grayish-black background. The tolerance levels are adjustable by the customer.

Since each substrate has a different profile, the present system generates a table for each type of paper or other media capable of receiving an image. In operation, the operator will select the media upon which the image will be printed and the table will display the values for that particular media. Although this information is calibrated for each media type, an operator will generally be allowed to modify the table to meet his specific needs.

To facilitate understanding of the system of the present invention, the printer detailed herein includes five stations or imaging units, which include only red, blue, or green as the available fifth station colors to supplement the current four-station cyan, magenta, yellow, and black (CMYK) traditional colors. However, these color conventions are included merely for ease of explanation and understanding and should not be limiting in any manner. In lieu of including either a red, blue, or green station as the fifth station, an operator could have any color from the available spectrum available as a fifth station in the printer. For instance, if an operator regularly had a number of jobs with colors that were in-gamut by installation of an orange station, the operator could request, and install, an orange station as the fifth station. The digital file would, in cooperation with the software, generate a column in the table for the orange station as the fifth station. This column would provide color accuracy values, including any tolerance allowance, to allow the operator to evaluate the gamut provided by installation of the orange station as desired by the operator and as required by the operator's jobs.

The present system is generally used in a printer that includes a traditional four printer station setup and which provides a bay or opening for a fifth station. However, this orientation is also not intended to be limiting in any manner as the present invention could be utilized in a five station system that includes a bay for a sixth station or in any station permutation that allows for the use of additional colors through additional stations in a printer. The present system generally will allow an operator to interchange only one of the stations, but could also allow for replacement of any of the four traditional CMYK stations. For example, the yellow station could be removed and replaced with green in the second bay, with the blue station being used in the fifth station to provide for a cyan, magenta, black, green, and blue color gamut. The exchangeable station need not be the last station in line as any or all of the stations able to be interchanged. However, to facilitate understanding and explanation of the system provided herein, a five-station printer has been presumed. Further, the printer can include any color as the fifth color, including, e.g., a second, brighter yellow color imaging unit that produces desired in-gamut values for a desired specific color could be used in the fifth station.

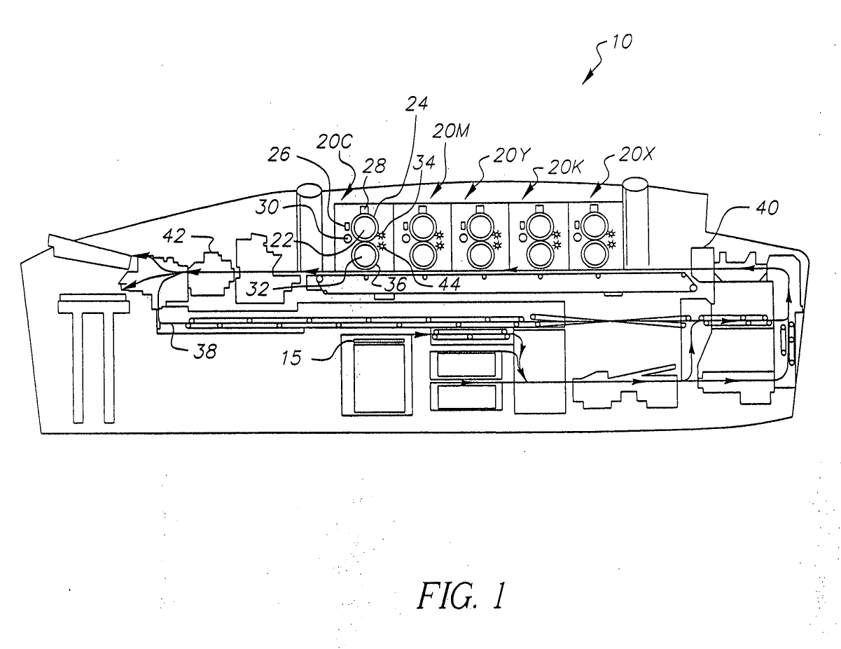

FIG. 1 shows a printer 10 that includes four imaging units (also referred to as development stations or electrostatographic image-forming modules) 20C, 20M, 20Y, 20K, and 20X. These stations are generally arranged in tandem and are shown in FIG. 1 in a specific arrangement with cyan, magenta, yellow, black and a fifth station in order. This invention, however, should not be limited to this or any other particular orientation. Each station includes elements that are similar from station to station and are shown in FIG. 1 to have similar referenced numerals with a suffix of C, M, Y, and K to refer to the station to which such element is respectively associated. Since each station is identical in construction, the specific elements specified herein are shown in FIG. 1 at one station only, but should be understood to apply in like manner to each station. Each station includes a primary image-forming member, for example, a drum or roller, 22. Each roller 22 has a respective photoconductive surface 24 having one or more layers upon which an image or a series of images is formed. To form a toned image, the outer surface of the rollers 22 are uniformly charged by a primary charger such as a corona charging device 26, or by any other suitable charger such as a roller charger, a brush charger, etc. The uniformly charged surface 24 is typically exposed by a image writer or exposure device 28, which is generally an LED or other electro-optical exposure device. Any alternative exposure device may be used, such as an optical exposure device to selectively alter the charge on the surface 24 of the roller 22. The exposure device 28 creates an electrostatic image that corresponds to an image to be reduced or generated. This electrostatic image is developed by applying marking particles to the latent image on the photoconductive drum 22 by a toner developing station 30. Each toner development station 30 is associated with a particular type of toner marking particle and magnetic carrier particle, which is typically in a preferred toner concentration and is attracted by a certain voltage supplied by a power supply (not shown). The image is transferred onto a transfer drum 32. After the transfer is made from the photoconductive drum 22, the residual toner image is cleaned from the surface 24 of the drum 22 by a suitable cleaning device 34. The cleaning device 34 then prepares the surface 24 of the drum 22 for reuse to form subsequent toner images. The intermediate or transfer drum 32 likewise is coated by a transfer surface 36, which can include one or more layers. The intermediate transfer drums 32 are each cleaned by respective cleaning devices 44 to prepare the transfer drums for reuse.

The imaging units 20 generally are in contact with a transport device, such as the shown endless belt or web 38, which can include receiver members adhered thereto for receipt of the paper or other media 15 that is to receive the image. In the alternative, the belt or web provided should not be restricted to the belt or web shown in FIG. 1 since the image transfer can be made on any suitable surface capable of receiving paper or other media as it passes between the imaging units. The web 38 can also detachably retain the paper electrostatically or by mechanical devices such as grippers. Typically, receiver members are electrostatically adhered to belt 38 by the deposit of electrostatic charges from a charging device, such as, for example, by using a corona charger 40. A sheet of paper 15 is shown in FIG. 1 proceeding along the belt 38 through each of the five imaging stations.

As shown in FIG. 1, the transfer drum 32 interacts with the paper 15 along the belt 38 to transfer the electrostatic image from the transfer surface 36 of the transfer drum 32. The paper 15 then proceeds in tandem order through each developing station. Once the paper 15 has passed through each imaging unit 20, the paper 15 proceeds to a detack charger 42 to deposit a neutralizing charge on the paper 15 to separate the paper 15 from the belt 38. The paper 15 proceeds past the detack charger 42 and is transported to a remote location for operator retrieval. The transfer of images in each imaging unit 20 are performed without the application of heat to negate any fusing or centering of toner images transferred to the paper 15 until the paper 15 enters a fuser (not shown) downstream. The paper 15 utilized herein can vary substantially in thickness and it is contemplated that this paper should not be limiting in any manner. For example, the paper can be thin or thick, include various paper stocks, transparencies stock, plastic sheet materials, and foils.

Although not shown, appropriate sensors of any well-known type, such as mechanical, electrical, or optical sensors, for example, generally are utilized in the printer to provide control signals for the printer. Such sensors may be located along the paper travel path along the belt 38, between the paper supply, and through the imaging units and the fusing station. Additional sensors may be associated with the photoconductive drums, the intermediate drums, any transferring mechanisms, and any of the image processing stations. Accordingly, the sensors can be provided to detect the location of the paper through its travel path in relation to each of the imaging units and can transmit appropriate signals indicative of the paper location. Such signals are input into a logic and control unit (not shown), which can include a microprocessor. Based on such signals and on the microprocessor, the control unit can output signals to the printer to control the timing operations of the various development stations or imaging units to process images and to control a motor (not shown) that drives the various drums and belts.

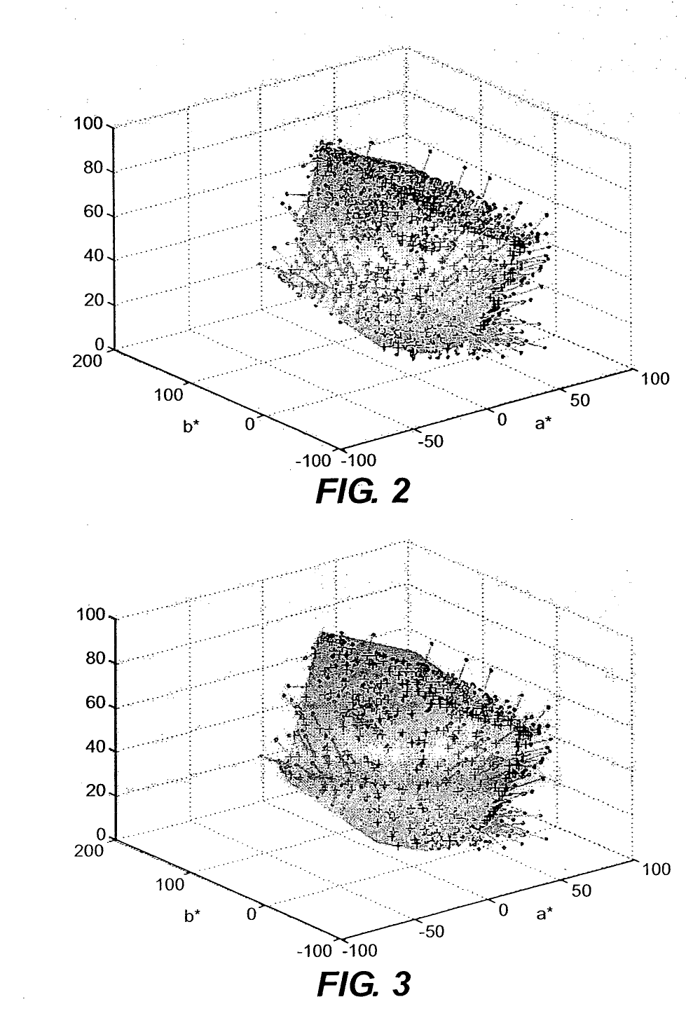

In order to make the informed choice of color accuracy versus efficiency to decide which color to insert in the fifth station, an operator is provided with the specific color patches in the digital file and is shown the available gamut of each different system configuration. FIG. 2 is a three-dimensional view of the CMYK gamut with in-gamut color patches shown within the solid volume and out-of-gamut patches that are out-of-gamut shown as dots. Projection lines are provided to show the distance outside the gamut for each out-of-gamut dot. The length of the projection lines represent the minimum color difference between the requested color patch (as provided by the digital file) and the best available color printable within the gamut of the four-color CMYK stations in the machine. By evaluating the digital file, the color gamut shown in FIG. 2 can be calculated to show which, and how far, a particular color patch is out-of-gamut. The in-gamut form of FIG. 2 shows the precise patch color match without accommodation for human visual tolerance or for drift inherent in the printing process. The actual color printed on the media can vary even greater than the out-of-gamut shown in FIG. 2 depending on the use of a color management system and depending on variability inherent in the process of printing the image. A color management system with color mapping engaged can be provided to measure the actual printed patch color after it has been transferred to the paper or other receiving surface.

A tolerance allowance usually is provided to enable the printer operator to distinguish values that are slightly out-of-gamut with values that are further out-of-gamut. FIG. 3 is a three-dimensional view of the CMYK gamut showing the out-of-gamut color patches of FIG. 1 with a tolerance allowance. As obvious from a comparison of the in-gamut volumes in FIG. 2 and FIG. 3, the color patches that are within the tolerance allowance noticeably increased the solid form. However, as evidenced by the dots and projection lines in FIG. 3, several color patches are still out-of-gamut of the CMYK system even if a tolerance level is included. The tolerance level shown in FIG. 3 is typically preset by the printer manufacturer to incorporate the allowable visual variations and drift from the printing process, but can be changed by the printer operator to a higher or lower tolerance level. For example, if the manufacturer sets a default tolerance level of four to account for visual acuity, which is seen as too high by the printer operator, the operator either can request the manufacturer to reset the tolerance himself after delivery of the printer. The CMYK color patches with a tolerance allowance are shown in the exemplary table of FIG. 8 discussed in further detail below.

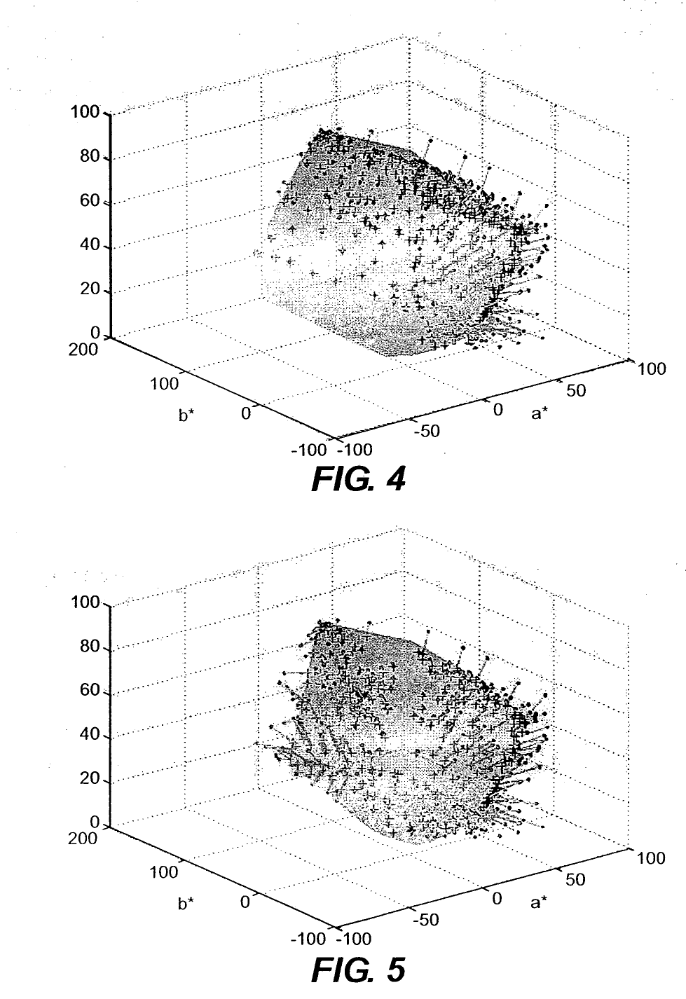

The in-gamut volumes shown in FIGS. 2 and 3 for four-color stations can be increased through the addition of a fifth color station. With a green color installed in the fifth station of the printer, the in-gamut color patches for colors that would be in-gamut with green as the fifth color will be increased. FIG. 4 is a three-dimensional view of the CMYK gamut including a tolerance with green included in the fifth station. FIG. 4 also utilizes dots with projection lines representation to show color patches that are out-of-gamut and the variance from being in-gamut. The in-gamut volume has been expanded in the green gamut region and many color patches in that region that were out-of-gamut in FIGS. 2 and 3 are now in-gamut. As seen in FIG. 4, the installed green station has little effect on the red or blue regions of the color patch volume.

With a red color installed in the fifth station of the printer, the in-gamut color patches for colors that would be in-gamut with red as the fifth color will be increased. FIG. 5 is a three-dimensional view of the CMYK gamut including a tolerance with red included in the fifth station. FIG. 5 also uses dots with projection lines to represent color patches that are out-of-gamut and the variance from being in-gamut. The in-gamut volume has been expanded in the red gamut region and many color patches that were out-of-gamut in FIGS. 2 and 3, are now in-gamut. As seen in FIG. 5, the installed red station has little effect on the green or blue regions of the color patch volume.

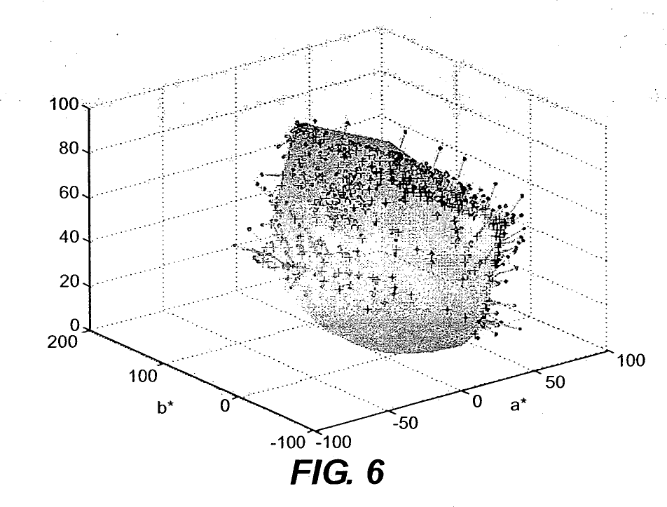

With a blue color installed in the fifth station of the printer, the in-gamut color patches for colors that would be in-gamut with blue as the fifth color will be increased. FIG. 6 is a three-dimensional view of the CMYK gamut including a tolerance with blue included in the fifth station. FIG. 6 also uses dots with projection lines to represent color patches that are out-of-gamut and the variance from being in-gamut. The in-gamut volume has been expanded in the blue gamut region and many color patches that were out-of-gamut in FIGS. 2 and 3, are now in-gamut. As seen in FIG. 6, the installed blue station has little effect on the green or red regions of the color patch volume.

While the installed green, red, and blue stations in FIGS. 4-6 have little effect on the gamut regions in the green, red, or blue volumes that are not installed as the fifth color, other colors used as the fifth color will effect other regions of the color patch volume. This noted negligible effect on certain regions of the gamut is noted for example purposes only for explanation of the present system and should not be limiting in any manner.

As obvious in comparing FIGS. 2 through 6, the addition of a fifth color station can greatly increase the color accuracy and color patch gamut. The present system presents a tabular value of this increase of the color patch volume and provides the operator an opportunity to control his workflow by installing a specific station in the fifth station at a specific time. Since the range of in-gamut color patch colors varies depending on the fifth station color installed, the volume of total specific colors that are in-gamut can be calculated and the percent of in-gamut colors versus total specific colors can be determined. Depending on which specific color is called for from the digital file, the gamut volume, number, and percentage of in-gamut colors generally increase for five station combinations over a four station CMYK gamut.

The in-gamut value universe that can be calculated for the additional colors a user has available, e.g. red, green, and blue stations for the fifth station. These calculations will allow a user to review the table, such as the one provided in FIG. 8 to see if the selected color is in-gamut at all in consideration of the particular user's universe of available colors. If his specific color is in-gamut under CMYK+RGB, the user can use the table to select the fifth color that will work. If his specific color is out-of-gamut, the user has three choices: first, to select the fifth color that is the closest match, second, to print the customer's job with the present printer station arrangement, or, third, to change to a different fifth color that is within this toner universe. As the user increases his selections of fifth colors, his available universe will grow to provide better coverage of specific colors. Thus, a user could have an entry in his table that included any number of fifth colors, e.g. CMYK+RGBOVY (CMYK plus red, green, blue, orange, violet, and another yellow), if he has these colors available to install as his fifth color.

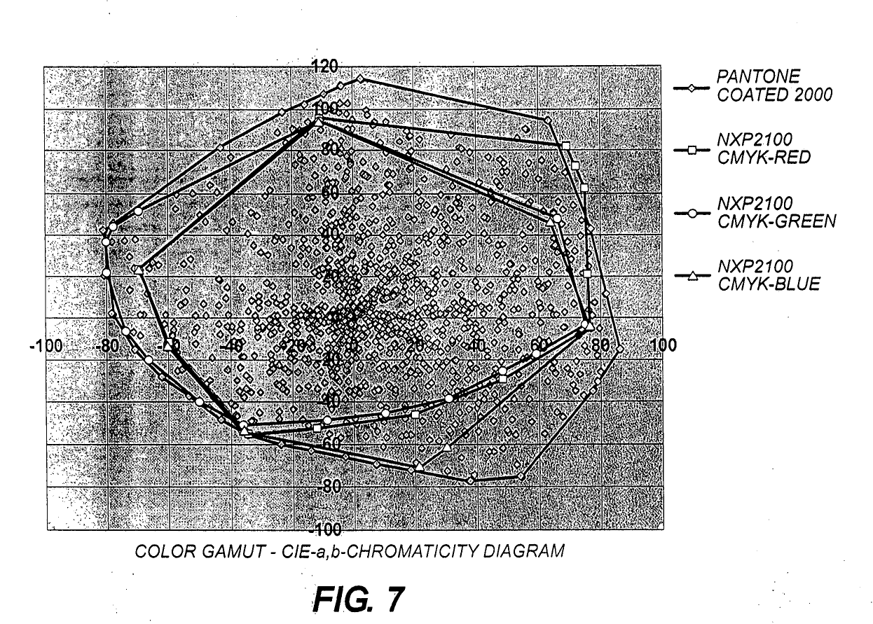

The present system provides an operator the information necessary to choose which color station to install as the fifth station in relation to the specific color requested by the digital file. To assist the operator in making the decision of which station to install, the printer provides color accuracy information to the operator. In FIG. 7, an operator can choose to view a provided chromaticity diagram to assist his determination of which fifth color to use to group his customer's jobs to optimize his workflow. Alternatively, or in addition to the diagram of FIG. 7, an operator can use a table, such as the one shown in FIG. 8, to determine which additional color station would be advantageous.

FIG. 7 shows a chromaticity diagram of the fifth color combination (e.g. CMYK+G) with Pantone® patches in comparison to a four-color CMYK system. Specifically, five gamuts are shown in FIG. 7, which, in many instances, overlap and encompass a majority of color patches in-gamut with each color combinations. Some of the color patch gamuts shown are outside the boundary region of a particular color combination, but in-gamut of another combination. An operator can use the diagram of FIG. 7 to decide which color to use as the fifth color. In order to make the diagram of FIG. 7 as reader friendly as possible, the diagram can be provided with different colors of boundary lines to distinguish whether the specific color is in-gamut. For example, the specific color can be displayed in FIG. 7 in red if it is out-of-gamut, in yellow if it is out-of-gamut but within the set tolerance, and green if it is in-gamut. These colors can be set by the user and will allow him to diagrammatically view whether a specific color is in-gamut using colors and a tolerance of his choosing.

FIG. 8 is a sample table of popular Pantone® colors and the various combinations provided by insertion of either a green, a red, or a blue color as the fifth station. The table of FIG. 8 shows certain Pantone® patches in-gamut with certain color combinations. FIG. 8 also shows if a specified color is out-of-gamut for a certain color combination and the amount out-of-gamut the Pantone® color will be is if that specific color combination is used in printing. Thus, an operator can use the table to assist in his choice of whether to print with the currently installed fifth station or whether to switch to a more suitable color combination to print the specified color. Workflow optimization can be utilized by enabling the grouping of jobs with a predominant color combination advantage.

FIG. 8 is displayed in easy-to-view, tabular form and shows the amount out-of-gamut of some Pantone® colors printed in CMYK within a tolerance or in CMYK+R, CMYK+G, CMYK+B, and CMYK+RGB, each within a tolerance. Values in-gamut are shown shaded in grayish black, values out-of-gamut but within a tolerance (the tolerance in FIG. 8 is 4) are shown gray with the difference from the gamut listed in each gray block, and values out-of-gamut and outside the tolerance region are shown white with the difference from in-gamut listed in each white block.

As an example, a customer presents a job to a printer operator as a digital file. The printer operator analyzes the digital file, which includes a corporate logo that includes a specific color. The present system presents, in tabular format (such as FIG. 8), a chromaticity diagram (such as FIG. 7), or other format, the gamut available from the addition of specific fifth colors. The specific color from the corporate logo is shown as an entry in FIG. 8 as Example Color A. Example Color A is outside the operator's present four-color CMYK gamut by 14 and is shown in the table over a white background since it is out-of-gamut more than the set tolerance level of 4. The operator has three available fifth colors, i.e. blue, green, and red. The table indicates, also over a white background, that the addition of red as the fifth color in the fifth station would still be out-of-gamut by 13. This slight improvement will not significantly improve on the CMYK number of 14. However, adding blue as the fifth color would only be out-of-gamut by 3.8, which is shown in the table over a grayed background since it is out-of-gamut, but within the set tolerance level. Further, the table indicates that adding green as the fifth color expands the gamut enough to bring Example Color A in-gamut. The use of green as the fifth color is shown in table in a grayish black shade to indicate an in-gamut value. Thus, a marked improvement in the color accuracy, from 14 to 3.8 or from 14 to in-gamut, would be realized by using either blue or green, respectively, as the fifth color.

The operator then decides that this particular customer's job is valuable and that the corporate logo will be an important image to print as accurately as possible. The operator can then analyze his workflow and group his jobs for increased efficiency. For instance, if the operator's other customer jobs entail specific colors that are in-gamut when using blue as the fifth color, the operator then could decide that the deviation in color accuracy, which is just slightly out-of-gamut, would be a close enough approximation to the desired Example Color A. The operator could decide that his workflow does not justify the time and effort required to replace the blue station with a green station to run the customer's job while realizing only minor improvement. However, if the operator's workflow involved a few customer jobs whose color accuracy would be improved by using a green station, the operator could group the Example Color A job with the other “green station” jobs and change the fifth station to the green station after running the jobs with the blue station.

In operation, a digital file is received from a customer that details a print job. The printer analyzes the digital file to determine which specific colors are specified in the document. In most digital files, several popular specific colors will be found. As another example, if a digital file requires Pantone® color #287, a review of the table in FIG. 8 would yield that the CMYK+B combination would be favorable since the Pantone® color would be in gamut. Since the operator currently has the red station in his printer, the operator has four choices. First, the operator can print the customer's job with the red station, CMYK+R, currently installed and with the knowledge that the particular Pantone® color is out-of-gamut. Second, the operator can switching to the red station for the blue station, CMYK+B, and be in-gamut for Pantone® #287. Third, the operator can delay the customer's job and switch the red station for the blue station later to allow the operator to group his other jobs that would benefit from the CMYK+B combination. Finally, the operator can remove the red station and print the customer's job with CMYK to slightly improve the Pantone® color accuracy since the out-of-gamut range is slightly improved. The operator would not benefit from switching to the green station since the color accuracy would not improve. These other color combinations do not yield a large enough improvement unless the user installs the blue station in the fifth station.

The present system can be extended to include the color accuracy of all Pantone® color patches available (generally after Color Management and mapping has been performed and verified), not just the out-of-gamut patches. The operator can then choose between using the current color combination and switching to a different combination.

As seen in FIG. 8, some Pantone® colors are not improved substantially or brought in-gamut with any of the CMYK plus a fifth color combinations shown. In such an instance, the table can be used by an operator to reach the best match possible in comparison with the CMYK+RGB plus tolerance value listed in an instance that involved all color combinations. For example, if the digital file indicated Pantone® Blue 072C, the combination with every station included (CMYK+RGB) is out-of-gamut by 9.9, but is still the closest to being in-gamut of all the values listed. The operator can analyze the table and determine which combination is closest to the value of 9.9. The CMYK+B combination is out-of-gamut by 10, which is the smallest deviation from the value of 9.9 with CMYK+RGB. The operator can then print the customer's job with the CMYK+B combination as the closest fit available. Thus, the table can be used to educate the operator as to the closest fit available to increase his workflow efficiency. Here, the operator is able to apply the present system without reordering his customer's job positions to improve his workflow.

While the invention has been disclosed in its preferred forms, it will be apparent to those skilled in the art that many modifications, additions, and deletions can be made therein without departing from the spirit and scope of the invention and its equivalents as set forth in the following claims.

### Parts List

10 printer
15 paper
20 imaging unit
22 drum/roller
24 surface
26 changer
28 exposure device
30 toner development station
32 transfer drum
34 cleaning device
36 transfer surface
38 belt or web
40 corona charger
42 detack charger
44 cleaning devices

1. A method of operating a printer with up to five imaging units in an imaging unit configuration, the configuration comprising at least four color imaging units and one interchangeable fifth color imaging unit, the imaging units providing a specific color gamut, the method comprising:
analyzing a digital file that includes a specific color that is outside the specific color gamut of the configuration;
analyzing a table of alternate configurations and exchanging the fifth color imaging unit for a different fifth color imaging unit;
choosing an alternate configuration from the table;
printing with the printer.

2. The method of claim 1, wherein the alternate configurations with the different fifth color imaging unit provide a different specific color gamut.

3. The method of claim 2, wherein the step of analyzing a table of alternate configurations includes comparing the specific color gamut of the configuration with the different specific color gamut of the alternate configuration.

4. The method of claim 3, wherein the different specific color gamut includes the specific color.

5. The method of claim 4, wherein after the step of analyzing a table of alternate configurations, the method further comprises:
exchanging the fifth color imaging unit for the different fifth color that includes the specific color.

6. The method of claim 2, wherein the specific color includes a value that is closer to the different specific color gamut than the specific color gamut.

7. The method of claim 6, wherein after the step of analyzing a table of alternate configurations, the method further comprises:
exchanging the fifth color imaging unit for the different fifth color that includes the specific color.

8. The method of claim 1, wherein before the choosing step, the method further comprises:
exchanging the fifth color imaging unit for the different fifth color.

9. The method of claim 1, wherein the four imaging units are individually exchangeable to include any four desired colors in the printer.

10. The method of claim 1, wherein the specific color is a spot color, a Pantone® color, a named color, or a customer-named color.

11. A method for predicting color accuracy in a printer with four-color imaging units that produce a four-color gamut and a fifth color imaging unit that, with the four color imaging units, produces a five-color gamut, the method comprising:
evaluating a digital file to determine if a specific color is specified;
determining if the specific color is outside the four-color gamut;
determining if the specific color is outside the fifth-color gamut;
comparing a difference from the four-color gamut with the five-color gamut to see if the specific color is closer to the five-color gamut than the four-color gamut.

12. The method of claim 11, wherein the four-color gamut includes a tolerance.

13. The method of claim 12, wherein the tolerance is an acceptable level that is preset.

14. The method of claim 13, wherein the tolerance can be reset.

15. The method of claim 11, wherein the five-color difference displayed includes a tolerance.

16. The method of claim 15, wherein the tolerance is an acceptable level that is preset.

17. The method of claim 16, wherein the tolerance can be reset.

18. The method of claim 11, wherein the four imaging units are individually exchangeable to include any four desired colors in the printer.

19. The method of claim 10, wherein the specific color is a spot color, a Pantone® color, a named color, or a customer-named color.

20. A method for predicting color accuracy of a specific color in a digital file, the method operates in a printer with five imaging units, the method comprising:
determining if the specific color is within a four-color gamut of four of the five units;
determining if the specific color is within a five-color gamut from the five units;
determining if the specific color is within a different five-color gamut with a different color installed in the different color imaging unit;
comparing the four-color gamut, the five-color gamut, and the different five-color gamut to see if the specific color is closer to the different five-color gamut than to the four-color gamut or to the five-color gamut.

21. The method of claim 20, wherein the five imaging units are individually exchangeable to include any five desired colors in the printer.

22. The method of claim 20, wherein the specific color is a spot color, a Pantone® color, a named color, or a customer-named color.

23. A printer with four imaging units that are capable of producing a four-color gamut and an interchangeable fifth imaging unit that is capable of producing a five-color gamut, the printer comprising:
means for receiving a digital file with a specific color;
means for analyzing the digital file to determine if the specific color is within the four-color gamut;
means for analyzing the digital file to determine if the specific color is within the five-color gamut; and,
means for displaying the four and five color gamut analyses to an operator to decide which color station to install in the fifth imaging unit.

24. The printer of claim 23, wherein the four-color gamut is less than the five-color gamut.

25. The printer of claim 23, wherein the four-color gamut includes a tolerance.

26. The method of claim 23, wherein the four imaging units are individually exchangeable to include any four desired colors in the printer.

27. The method of claim 23, wherein the specific color is a spot color, a Pantone® color, a named color, or a customer-named color.

28. A method of expanding a color gamut of a printer, the printer having four imaging units capable of producing a four-color gamut and one imaging unit bay that is capable of receiving a fifth color station, the fifth color station producing a five-color gamut when installed in the printer, the method comprising:
analyzing a digital file for a specific color;
determining if the specific color is in the four-color gamut;
determining if the specific color is in the five-color gamut for each color capable of being installed in the bay;
displaying the specific color, the four-color gamut and the five-color gamut;
receiving an input from an operator indicating which color station is installed in the bay; and,
operating the printer based on the input.

29. The method of claim 28, wherein the four imaging units are individually exchangeable to include any four desired colors in the printer.

30. The method of claim 28, wherein the specific color is a spot color, a Pantone® color, a named color, or a customer-named color.

31. A method of improving efficiency in a workflow operation for a printer, the printer includes five imaging unit bays that house four imaging units and at least one interchangeable imaging unit, the method comprising:
analyzing a digital file for a specific color;
determining if the specific color is in a four-color gamut;
determining if the specific color is in a five-color gamut;
displaying the specific color, the four-color gamut, and the five-color gamut;
receiving an input from an operator indicating which color station is installed in the bay; and,
operating the printer based on the input.

32. The method of claim 31, wherein the four imaging units are individually exchangeable to include any four desired colors in the printer.

33. The method of claim 31, wherein the displaying step is presented in a table.

34. The method of claim 33, wherein the table includes a tolerance level.

35. The method of claim 31, wherein any of the four imaging units are also interchangeable.

36. The method of claim 31, wherein the specific color is a spot color, a Pantone® color, a named color, or a customer-named color.

37. A method of operating a printer with four imaging units capable of producing a four-color gamut and a fifth station bay capable of receiving a fifth color station, the fifth color station being capable of producing a five-color gamut when installed, the method comprising:
indicating a media to be imaged;
providing a digital file that includes a specific color to the printer, wherein the printer displays variance values of the specific color from the four-color gamut and to the five-color gamut;
determining which color to install in the fifth station bay based on the variance values;
operating the printer based on the determining step.

38. The method of claim 37, wherein the specific color is a spot color, a Pantone® color, a named color, or a customer-named color.

39. The method of claim 37, wherein the four imaging units are individually exchangeable to include any four desired colors in the printer.
